(19) United States
(12) Patent Application Publication
(10) Pub. No.: US 2010/0328217 A1
(43) Pub. Date: Dec. 30, 2010

(54) APPARATUS AND METHOD FOR ACCESSING INFORMATION DESIGNATED AS BEING RELEVANT IN AN EMERGENCY

(75) Inventor: Keld Stougaard, Karlslunde (DK)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/490,821

(22) Filed: Jun. 24, 2009

(51) Int. Cl. G06F 3/02

(52) U.S. Cl. 345/168

(57) ABSTRACT

An apparatus is provided that includes a processor and a memory storing executable instructions that in response to execution by the processor cause the apparatus to at least perform a number of operations. These operations may include presenting on a display an indication of information designated as being relevant in an emergency, where the indication is presented associated with a soft key of a keypad, and where the indication is presented without the display also presenting the information. The operations may also include receiving selection of the indication by a user of the apparatus actuating the soft key of the keypad, and presenting on the display the information in response to receiving the selection and without also receiving selection of other keys of the keypad.

### TECHNICAL FIELD

Embodiments of the present invention generally relate to an apparatus and method for accessing information and, more particularly, relate to an apparatus and method for accessing information designated as being relevant in an emergency, such as “In Case of Emergency” (ICE) information.

### BACKGROUND

In order to provide easier or faster information transfer and convenience, telecommunication industry service providers are continually developing improvements to existing communication networks. As a result, wireless communication has developed increased reliability and quality and has become increasingly popular in recent years. Along with the expansion and improvement of wireless communication networks, mobile electronic devices used for wireless communication have also been continually improving. In this regard, due at least in part to reductions in size and cost, along with improvements in battery life and computing capacity, mobile electronic devices have become more capable, easier to use, and cheaper to obtain. Due to the now ubiquitous nature of mobile electronic devices, people of all ages and education levels are utilizing mobile terminals to communicate with other individuals or contacts, receive services and/or share information, media and other content.

Recently, the “In Case of Emergency” (ICE) program has been developed to promote the use of mobile electronic devices to designate and store emergency-related information for the owners of such devices. This information principally includes emergency contact information, but also contemplates other medical or contact-related information. As initially promoted, the program encouraged users to store ICE information in their address books (available on many mobile electronic devices) with the designation “ICE” so that the information could be easily located by first responders to an emergency. And although this manner of storing and accessing emergency-related information is adequate, it would be desirable to develop a system and method for accessing such information in a quicker and more intuitive manner.

### BRIEF SUMMARY

In view of the foregoing background, example embodiments of the present invention provide an apparatus including a processor and a memory storing executable instructions that in response to execution by the processor cause the apparatus to at least perform a number of functions that enable quick and intuitive access to emergency information. In this regard, the functions include presenting on a display an indication of information designated as being relevant in an emergency, where the indication is presented associated with a soft key of a keypad, and where the indication is presented without the display also presenting the information. The functions also include receiving selection of the indication by a user of the apparatus actuating the soft key of the keypad, and presenting on the display the information in response to receiving the selection and without also receiving selection of other keys of the keypad.

The information may include information for or regarding a first user (e.g., owner) of the apparatus, such as one or more of emergency contact information, medical information, language (spoken and/or written) or travel itinerary information. In such instances, selection of the indication may be received by the first user or a second user (e.g., first responder to an emergency) actuating the soft key of the keypad.

In various instances, the apparatus may have a locked state in which input of a password is required to enable functionality of the apparatus. In such instances, the indication may be presented, the selection may be received and the information may be presented when the apparatus is in the locked state (requiring input of the password to enable other functionality of the apparatus).

Also in various instances, the information may be stored on an integrated circuit card (ICC), which may be accessed to present the information on the display, and which may have a locked state in which input of a personal identification number (PIN) is required to enable access to information on the ICC. In these instances, the indication may be presented, the selection may be received and the information may be presented when the ICC is in the locked state (requiring input of the PIN to enable access to other information on the ICC). In this regard, the indication may be presented, the selection may be received and the information may be presented when the apparatus is unconnected to a network.

More particularly, for example, the indication may be presented upon the apparatus being powered on and entering a wait state. The apparatus may thereby be enabled to receive selection of the indication and present on the display the information upon the indication being presented on the display.

According to other aspects of the present invention, a method and computer-readable storage medium are provided. As indicated above and explained below, the apparatus, method and computer-readable storage medium of example embodiments of the present invention may solve the problems identified by prior techniques and/or provide additional advantages.

### BRIEF DESCRIPTION OF THE DRAWINGS

Having thus described the invention in general terms, reference will now be made to the accompanying drawings, which are not necessarily drawn to scale, and wherein:

FIGS. 1 and 2 are block diagrams of an apparatus according to example embodiments of the present invention; and

FIG. 3 is a state graph illustrating states in an access procedure, according to example embodiments of the present invention.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments of the present invention, to refer to data capable of being transmitted, received, operated on, and/or stored.

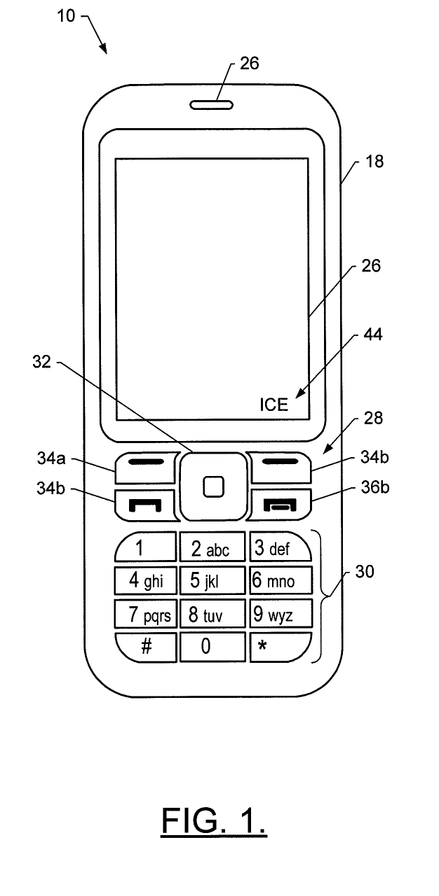

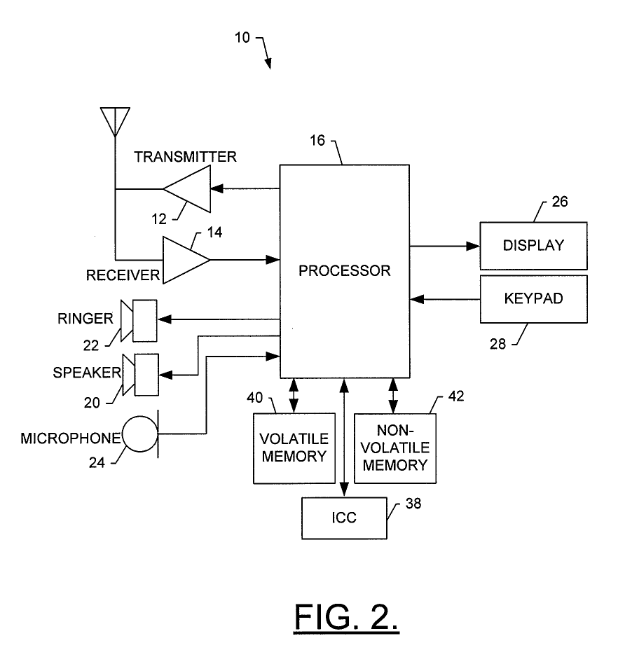

FIGS. 1 and 2 illustrate block diagrams of an apparatus 10, according to example embodiments of the invention. It should be understood that the apparatus illustrated and hereinafter described is merely illustrative of one type of apparatus that would benefit from embodiments of the present invention and, therefore, should not be taken to limit the scope of embodiments of the present invention. As shown and described herein, the apparatus may be embodied in any of a number of different manners, such as by a personal computer, laptop or other mobile computer, server computer, mobile terminal (e.g., mobile telephone), portable digital assistant (PDA), pager, mobile television, gaming device, camera, video recorder, audio/video player, radio, global positioning system (GPS) device or the like.

The apparatus may include various means for performing one or more functions in accordance with example embodiments of the present invention, including those more particularly shown and described herein. It should be understood, however, that the apparatus may include alternative means for performing one or more like functions, without departing from the spirit and scope of embodiments of the present invention. More particularly, for example, as shown in FIGS. 1 and 2, the apparatus may include a transmitter 12, a receiver 14, and a processor 16 configured to direct signals to and from the transmitter and receiver, respectively. These signals may include signaling information in accordance with the air interface standard of the applicable wireless system, and also user speech and/or user generated data.

The apparatus 10 may be configured to operate with one or more air interface standards, communication protocols, modulation types, and access types. More particularly, the apparatus may be configured to connect to a public land mobile network (PLMN) and communicate across the PLMN in accordance with any of a number of first-generation (1G), second-generation (2G), 2.5G, third-generation (3G), 3.9G and/or fourth-generation (4G) communication protocols or the like. For example, the apparatus may be configured to operate in accordance with 2G wireless communication protocols IS-136 (TDMA), GSM, IS-95 (CDMA) or the like. Also, for example, the apparatus may be configured to operate in accordance with 2.5G wireless communication protocols GPRS, Enhanced Data GSM Environment (EDGE), or the like. Some example 3G protocols with which the apparatus may be configured to operate include the Universal Mobile Telecommunications System (UMTS), CDMA2000, wideband CDMA (WCDMA) and time division-synchronous CDMA (TD-SCDMA); 3.9G wireless communication protocols include, for example, Evolved Universal Terrestrial Radio Access Network (E-UTRAN). Other example protocols with which the apparatus may be configured to operate include international mobile telecommunications advanced (IMT-Advanced) protocols, Long Term Evolution (LTE) protocols including LTE-advanced, or the like.

The processor 16 may be embodied as various means implementing various functionality of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. In some example embodiments, the processor may (but need not) include one or more accompanying digital signal processors. The processor may be configured to execute instructions stored in memory or other computer-readable storage medium (described below) or otherwise accessible to the processor. The processor may therefore represent an entity capable of performing operations according to embodiments of the present invention while configured accordingly. For example, when the processor is embodied as an ASIC, FPGA or the like, the processor may be specifically configured hardware for conducting one or more operations described herein. Alternatively, when the processor is embodied as an executor of instructions stored on a computer-readable storage medium, the instructions may specifically configure the processor to perform one or more operations described herein. In some cases, however, the processor may be a processor of a specific device (e.g., a mobile terminal) configured for employing example embodiments of the present invention by further configuration of the processor via executed instructions for performing one or more operations described herein.

The apparatus 10 may also include a housing 18 supporting a user interface having an earphone or speaker 20, a ringer 22, a microphone 24, a display 26, and a user input interface, all of which are coupled to the processor 16. The user input interface, which allows the apparatus to receive data, may comprise any of a number of devices allowing the apparatus to receive data, such as a keypad 28, a touch display (touch screen) or other input device. In this regard, the display may be implemented as a touch screen, and in such instances may implement all or a portion of the keypad. The keypad may include the conventional numeric (0-9) and related (#, *) keys 30, and other keys used for operating the apparatus. For example, the keypad may additionally or alternatively include a navigation-plus-select key 32 for navigating and selecting functions of the apparatus, left and right soft keys 34a, 34b selecting functions indicated on the display above the respective soft keys. Also, for example, the keypad may include an off-hook and on-hook keys 36a, 36b for initiating or accepting a call and terminating or rejecting a call, respectively.

Although not shown, the apparatus may also include one or more means for sharing and/or obtaining data from other apparatuses. For example, the apparatus may include a radio frequency (RF) transceiver and/or an infrared (IR) transceiver such that the apparatus may share and/or obtain data in accordance with radio frequency and/or infrared techniques. Also, for example, the apparatus may include a Bluetooth (BT) transceiver such that the apparatus may share and/or obtain data in accordance with Bluetooth transfer techniques. Although not shown, the apparatus may additionally or alternatively be configured to transmit and/or receive data from other apparatuses according to a number of different wireline and/or wireless networking techniques, including LAN and/or WLAN techniques.

The apparatus may further include memory, such as an integrated circuit card (ICC) 38, which typically stores information elements related to a mobile subscriber. In one example embodiment in the context of GSM and UMTS applications, for example, the ICC may comprise a universal ICC (UICC). This UICC may include a subscriber identity module (SIM) application, universal SIM (USIM) application, IMS SIM (ISIM) application or the like for accessing corresponding PLMNs, although it should be understood that one or more of these applications may also be used to access one or more other networks. In addition to the ICC, the apparatus may include other memory, such as volatile memory 40, and/or other non-volatile memory 42 (embedded and/or may be removable non-volatile memory). For example, the other non-volatile memory may comprise embedded or removable multimedia memory cards (MMCs), Memory Sticks manufactured by Sony Corporation, EEPROM, flash memory, hard disk or the like.

The memories 38, 40 and 42 may store any of a number of pieces of information, and data, used by the apparatus to implement the functions of the apparatus. In accordance with example embodiments of the present invention, the ICC and/or non-volatile memory may store information designated as being relevant in an emergency, which may be referred to as “In Case of Emergency” (ICE) information. This information may be used to enable first responders such as medical personnel, firefighters or police officers in case of an emergency involving the apparatus's user. The information may include any of a number of different pieces of information for or regarding the user including, for example, emergency contact information (e.g., telephone numbers), pertinent medical information (e.g., allergies), home address, language (e.g., spoken and/or written), travel itinerary information or the like. The information may be formatted in any of a number of different manners, such as in accordance with the 3GPP Standard, 3GPP TS 22.101.

In accordance with example embodiments of the present invention, the ICE information may be accessed by the apparatus 10 being configured to present an indication 44 of the ICE information above one of the soft keys 34a, 34b such that the apparatus responds to actuation of the soft key by displaying or otherwise presenting the ICE information. The ICE information may be accessed when the apparatus is operating in any of a number of different states, provided that the apparatus is powered on. More particularly, the ICE information may be accessed when the apparatus is in a locked state (requiring input of a password to enable other functionality of the apparatus) or in an unlocked state (functionality of the apparatus enabled). The ICE information may be accessed when the ICC 38 is in a locked state (requiring input of a personal identification number—PIN—to access other information on the ICC) or in an unlocked state (access to other information on the ICC enabled). And in this regard, the ICE information may be accessed regardless of whether the apparatus is connected to a PLMN—and may therefore be accessed when the apparatus is unconnected to a PLMN or other network.

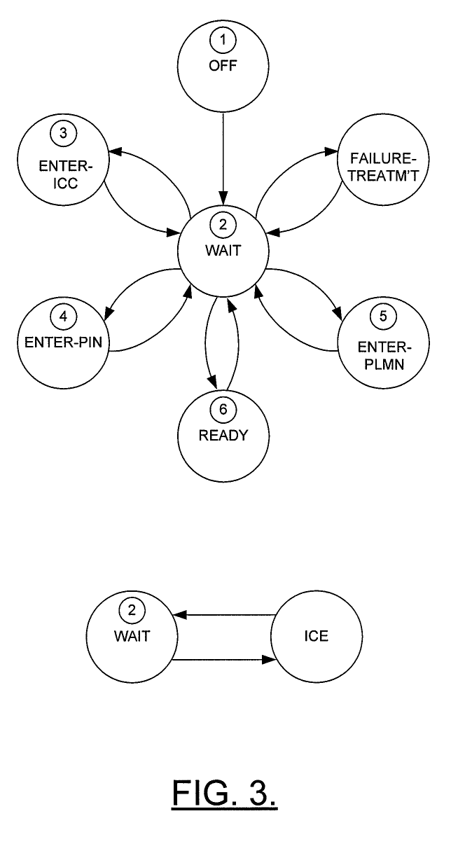

Reference is now made to FIG. 3 which illustrates a state graph of states of the apparatus 10 connecting to a PLMN in accordance with example embodiments of the present invention. As shown and described herein, various ones of the states may be implemented in any of a number of different manners, such as in accordance with the 3GPP Standard (e.g., 3GPP TS 22.030). As shown, upon being powered on from an off state, the apparatus may enter a wait state. The apparatus may then proceed through a number of different access states, following each of which the apparatus may return to the wait state. In this regard, after being powered on, if the ICC 38 is removable and has not been inserted into the apparatus, the apparatus may prompt the user to enter the ICC. The ICC may be in a locked state, and if so, the apparatus may prompt the user to enter, and receive from the user, the appropriate PIN for the ICC. After receiving the appropriate PIN, the apparatus 10 may access application(s) and information on the ICC for accessing a PLMN. The apparatus may request selection of a PLMN or otherwise select a default PLMN, and after receiving or selecting the PLMN, the apparatus may enter a ready state in which services of the PLMN are available to the apparatus.

As also shown, one or more of the access states or transitions from one state to another may cause a failure condition. In such instances, the apparatus 10 may correct or otherwise request that the user correct the failure, or may cease the access procedure if the failure cannot be corrected.

Further, and in accordance with example embodiments of the present invention, upon and at any point after being powered on, the apparatus may present an indication 44 of the ICE information on its display 26 above and associated with one of its soft keys 34a, 34b. At any point in the access procedure or thereafter in the access state, then, the apparatus may receive an indication of actuation of the respective soft key. In response to actuation of the soft key and without requiring the user to actuate other keys of the keypad 28 or provide other input, the apparatus may access the ICE information in memory of the apparatus, and present the ICE information on the display 26. Sometime after presenting the ICE information, the apparatus may receive an indication to close display of the ICE information.

According to one aspect of the present invention, the functions performed by the apparatus 10 may be performed by various means, such as hardware and/or firmware, including those described above, alone and/or under control of computer-readable program code portions, such as a series of computer instructions. These computer-readable program code portions for performing one or more functions of embodiments of the present invention may form part of a computer program product that also includes a computer-readable storage medium within which the computer-readable program code portions may be embodied.

FIG. 3 is a state graph of a method, apparatus and program product according to the invention. It will be understood that each block or step of the state graph, and combinations of blocks or steps in the state graph, can be implemented by various means, such as hardware, firmware, and/or a computer program product including one or more computer program instructions. As will be appreciated, any such computer program instructions may be loaded onto a computer or other programmable apparatus (i.e., hardware) to produce a machine, such that the instructions which execute on the computer or other programmable apparatus implement the functions specified in the state graph's block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the state graph's block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the state graph's block(s) or step(s).

Accordingly, blocks or steps of the state graph support combinations of means for performing the specified functions, or combinations of steps for performing the specified functions. It will also be understood that one or more blocks or steps of the state graph, and combinations of blocks or steps in the state graph, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising a processor and a memory storing executable instructions that in response to execution by the processor cause the apparatus or another apparatus to at least perform the following:
presenting on a display an indication of information designated as being relevant in an emergency, the indication being presented associated with a soft key of a keypad, the indication being presented without the display also presenting the information;
receiving selection of the indication by a user of the apparatus actuating the soft key of the keypad; and
presenting on the display the information in response to receiving the selection and without also receiving selection of other keys of the keypad.

2. The apparatus of claim 1, wherein the information comprises information for or regarding a first user of the apparatus, the information including one or more of emergency contact information, medical information, spoken or written language, or travel itinerary information, and
wherein receiving selection of the indication comprises receiving selection of the indication by the first user or a second user of the apparatus actuating the soft key of the keypad.

3. The apparatus of claim 1, wherein presenting on a display an indication, receiving selection of the indication and presenting on the display the information occur when the apparatus is in a locked state, the locked state requiring input of a password to the apparatus to enable other functionality of the apparatus.

4. The apparatus of claim 1, wherein the information is stored on an integrated circuit card, wherein presenting on the display the information includes accessing the information from the integrated circuit card, and
wherein presenting on a display an indication, receiving selection of the indication and presenting on the display the information occur when the integrated circuit card is in a locked state, the locked state requiring input of a personal identification number to the apparatus to enable access to other information on the integrated circuit card.

5. The apparatus of claim 1, wherein presenting on a display an indication, receiving selection of the indication and presenting on the display the information occur when the apparatus is unconnected to a network.

6. The apparatus of claim 1, wherein presenting on a display an indication occurs upon the apparatus being powered on and entering a wait state, the apparatus being enabled to receive selection of the indication and present on the display the information upon the indication being presented on the display.

7. A method comprising:
presenting on a display of an apparatus an indication of information designated as being relevant in an emergency, the indication being presented associated with a soft key of a keypad, the indication being presented without the display also presenting the information;
receiving selection of the indication by a user of the apparatus actuating the soft key of the keypad; and
presenting on the display the information in response to receiving the selection and without also receiving selection of other keys of the keypad.

8. The method of claim 7, wherein the information comprises information for or regarding a first user of the apparatus, the information including one or more of emergency contact information, medical information, language or travel itinerary information, and
wherein receiving selection of the indication comprises receiving selection of the indication by the first user or a second user of the apparatus actuating the soft key of the keypad.

9. The method of claim 7, wherein presenting on a display an indication, receiving selection of the indication and presenting on the display the information occur when the apparatus is in a locked state, the locked state requiring input of a password to the apparatus to enable other functionality of the apparatus.

10. The method of claim 7, wherein the information is stored on an integrated circuit card, wherein presenting on the display the information includes accessing the information from the integrated circuit card, and
wherein presenting on a display an indication, receiving selection of the indication and presenting on the display the information occur when the integrated circuit card is in a locked state, the locked state requiring input of a personal identification number to the apparatus to enable access to other information on the integrated circuit card.

11. The method of claim 7, wherein presenting on a display an indication, receiving selection of the indication and presenting on the display the information occur when the apparatus is unconnected to a network.

12. The method of claim 7, wherein presenting on a display an indication occurs upon the apparatus being powered on and entering a wait state, the apparatus being enabled to receive selection of the indication and present on the display the information upon the indication being presented on the display.

13. A computer-readable storage medium having computer-readable program code portions stored therein that in response to execution by a processor cause an apparatus to at least perform the following:
presenting on a display an indication of information designated as being relevant in an emergency, the indication being presented associated with a soft key of a keypad, the indication being presented without the display also presenting the information;
receiving selection of the indication by a user of the apparatus actuating the soft key of the keypad; and
presenting on the display the information in response to receiving the selection and without also receiving selection of other keys of the keypad.

14. The computer-readable storage medium of claim 13, wherein the information comprises information for or regarding a first user of the apparatus, the information including one or more of emergency contact information, medical information, language or travel itinerary information, and
wherein receiving selection of the indication comprises receiving selection of the indication by the first user or a second user of the apparatus actuating the soft key of the keypad.

15. The computer-readable storage medium of claim 13, wherein presenting on a display an indication, receiving selection of the indication and presenting on the display the information occur when the apparatus is in a locked state, the locked state requiring input of a password to the apparatus to enable other functionality of the apparatus.

16. The computer-readable storage medium of claim 13, wherein the information is stored on an integrated circuit card, wherein presenting on the display the information includes accessing the information from the integrated circuit card, and
wherein presenting on a display an indication, receiving selection of the indication and presenting on the display the information occur when the integrated circuit card is in a locked state, the locked state requiring input of a personal identification number to the apparatus to enable access to other information on the integrated circuit card.

17. The computer-readable storage medium of claim 13, wherein presenting on a display an indication, receiving selection of the indication and presenting on the display the information occur when the apparatus is unconnected to a network.

18. The computer-readable storage medium of claim 13, wherein presenting on a display an indication occurs upon the apparatus being powered on and entering a wait state, the apparatus being enabled to receive selection of the indication and present on the display the information upon the indication being presented on the display.
